(19) United States
(12) Patent Application Publication
(10) Pub. No.: US 2023/0353844 A1
(43) Pub. Date: Nov. 2, 2023

(54) VIDEO GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Jiayi LI, Beijing (CN); Rufeng XUE, Beijing (CN)

(21) Appl. No.: 18/217,215

(22) Filed: Jun. 30, 2023

Related U.S. Application Data
(63) Continuation of application No. PCT/CN2021/143197, filed on Dec. 30, 2021.

(30) Foreign Application Priority Data
Dec. 31, 2020 (CN) 202011624042.4

(51) Int. Cl. H04N 21/854; H04N 21/44; H04N 21/472

(52) U.S. Cl. CPC H04N 21/854; H04N 21/44016; H04N 21/47205

(57) ABSTRACT

Provided are a video generation method and apparatus, an electronic device, and a storage medium. The method includes: receiving a first trigger operation for using a target template (S101); in response to the first trigger operation, displaying a target template homepage of the target template and displaying scene description information about multiple target scenes of the target template in the target template homepage (S102); receiving a second trigger operation for adding a scene video of any target scene (S103); in response to the second trigger operation, adding a scene video of a target scene corresponding to the second trigger operation (S104); and synthesizing scene videos of the multiple target scenes into a target video according to the sequence of the multiple target scenes in the target template homepage (S105).

### CROSS-REFERENCE TO RELATED APPLICATIONS

This application is a continuation of International Patent Application No. PCT/CN2021/143197, filed on Dec. 30, 2021, which claims priority to Chinese Patent Application No. 202011624042.4 filed on Dec. 31, 2020, the disclosures of both of which are incorporated herein by reference in their entireties.

### TECHNICAL FIELD

Embodiments of the present disclosure relate to the field of computer technologies and, for example, to a video generation method and apparatus, an electronic device, and a storage medium.

### BACKGROUND

At present, some video software provides a user with a video template, and the user may upload photos or video segments in the video template. Thus, the video software may synthesize the photos or video segments uploaded by the user into one video to simplify operations necessary for the user to generate the video.

However, the photos or video segments uploaded by the user are simply synthesized into the video by the video template in the related art. The content of the video segments is less coherent, so a video with story logic cannot be generated.

### SUMMARY

Embodiments of the present disclosure provide a video generation method and apparatus, an electronic device, and a storage medium to improve the coherence of content between different video segments and generate a video with story logic.

In a first aspect, embodiments of the present disclosure provide a video generation method. The method includes the steps below.

A first trigger operation for using a target template is received.

In response to the first trigger operation, a target template homepage of the target template is displayed and scene description information about multiple target scenes of the target template is displayed in the target template homepage.

A second trigger operation for adding a scene video of any target scene is received.

In response to the second trigger operation, a scene video of a target scene corresponding to the second trigger operation is added.

Scene videos of the multiple target scenes are synthesized into a target video according to the sequence of the multiple target scenes in the target template homepage.

In a second aspect, embodiments of the present disclosure further provide a video generation apparatus. The apparatus includes a first trigger module, a homepage display module, a second trigger module, a video adding module, and a video synthesis module.

The first trigger module is configured to receive a first trigger operation for using a target template.

The homepage display module is configured to, in response to the first trigger operation, display a target template homepage of the target template and display scene description information about multiple target scenes of the target template in the target template homepage.

The second trigger module is configured to receive a second trigger operation for adding a scene video of any target scene.

The video adding module is configured to, in response to the second trigger operation, add a scene video of a target scene corresponding to the second trigger operation.

The video synthesis module is configured to synthesize scene videos of the multiple target scenes into a target video according to the sequence of the multiple target scenes in the target template homepage.

In a third aspect, embodiments of the present disclosure further provide an electronic device.

The electronic device includes one or more processors and a memory.

The memory is configured to store one or more programs. When executed by the one or more processors, the one or more programs cause the one or more processors to implement the video generation method according to the embodiments of the present disclosure.

In a fourth aspect, embodiments of the present disclosure further provide a non-transitory computer-readable storage medium storing a computer program which, when executed by a processor, implements the video generation method according to the embodiments of the present disclosure.

### BRIEF DESCRIPTION OF DRAWINGS

The same or similar reference numerals in the drawings denote the same or similar elements. It is to be understood that the drawings are schematic and that originals and elements are not necessarily drawn to scale.

FIG. 1 is a flowchart of a video generation method according to an embodiment of the present disclosure;

FIG. 2 is a schematic diagram of a creation homepage according to an embodiment of the present disclosure;

FIG. 3 is a schematic diagram of a template list page according to an embodiment of the present disclosure;

FIG. 4 is a schematic diagram of a target template homepage according to an embodiment of the present disclosure;

FIG. 5 is a schematic diagram of another target template homepage according to an embodiment of the present disclosure;

FIG. 6 is a schematic diagram of a newly added scene page according to an embodiment of the present disclosure;

FIG. 7 is a schematic diagram of a sequence adjustment window according to an embodiment of the present disclosure;

FIG. 8 is a schematic diagram of an adding mode selection window according to an embodiment of the present disclosure;

FIG. 9 is a schematic diagram of a shooting guide page according to an embodiment of the present disclosure;

FIG. 10 is a schematic diagram of a third target template homepage according to an embodiment of the present disclosure;

FIG. 11 is a schematic diagram of a video preview page according to an embodiment of the present disclosure;

FIG. 12 is a flowchart of another video generation method according to an embodiment of the present disclosure;

FIG. 13 is a schematic diagram of a video shooting page according to an embodiment of the present disclosure;

FIG. 14 is a schematic diagram of a progress pop-up window according to an embodiment of the present disclosure;

FIG. 15 is a schematic diagram of a video editing page according to an embodiment of the present disclosure;

FIG. 16 is a schematic diagram of a draft box page according to an embodiment of the present disclosure;

FIG. 17 is a block diagram of a video generation apparatus according to an embodiment of the present disclosure; and

FIG. 18 is a structural diagram of an electronic device according to an embodiment of the present disclosure.

### DETAILED DESCRIPTION

Embodiments of the present disclosure are described in more detail hereinafter with reference to the drawings. The drawings illustrate some embodiments of the present disclosure, but it is to be understood that the present disclosure may be implemented in various manners and should not be construed as being limited to the embodiments set forth herein. On the contrary, these embodiments are provided to facilitate a more thorough and complete understanding of the present disclosure. It is to be understood that the drawings and embodiments of the present disclosure are merely illustrative and are not intended to limit the scope of the present disclosure.

It is to be understood that steps described in method implementations of the present disclosure may be performed in sequence and/or in parallel. Additionally, the method implementations may include additional steps and/or omit some of the illustrated steps. The scope of the present disclosure is not limited in this respect.

The term “include” and variations thereof used herein refer to “including, but not limited to”. The term “based on” refers to “at least partially based on”. The term “an embodiment” refers to “at least one embodiment”. The term “another embodiment” refers to “at least one another embodiment”. The term “some embodiments” refers to “at least some embodiments”. Definitions of other terms are given in the description hereinafter.

It is to be noted that concepts such as “first” and “second” in the present disclosure are used to distinguish between apparatuses, between modules, or between units and are not intended to limit the sequence or mutual dependence of the functions performed by these apparatuses, modules, or units.

It is to be noted that modifications “one” and “multiple” mentioned in the present disclosure are illustrative instead of restrictive and should be construed as “one or more” by those skilled in the art, unless otherwise clearly indicated in the context.

The names of messages or information exchanged between apparatuses in the implementations of the present disclosure are only used for illustrative purposes and are not intended to limit the scope of the messages or information.

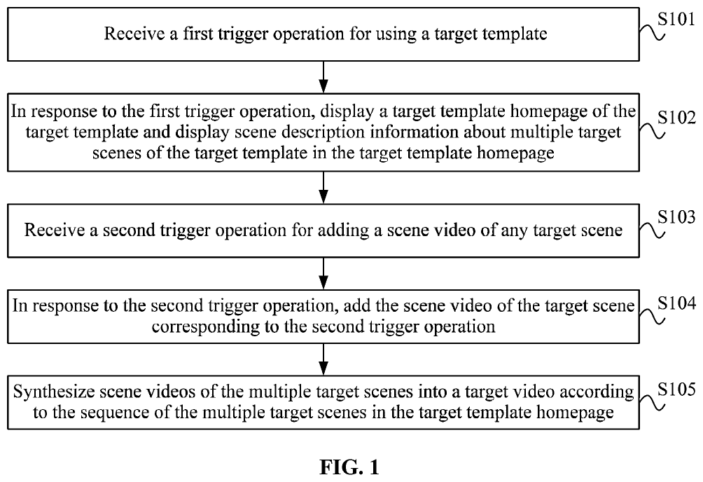

FIG. 1 is a flowchart of a video generation method according to an embodiment of the present disclosure. The method may be performed by a video generation apparatus. The apparatus may be implemented in software and/or hardware and may be configured in an electronic device such as a mobile phone or a tablet computer. As shown in FIG. 1, the video generation method provided in this embodiment may include the steps described below.

In S101, a first trigger operation for using a target template is received.

The target template may be understood as a video generation template for generating a video this time. The video production template may be set in advance by a developer. Different video generation templates may be used for producing different types of videos. The video generation template may be a food recipe template, a food tour template, a travel journal template, an unboxing review template, a good thing sharing template, an eating show template, a hotel experience template, or the like. Each video generation template may be provided with multiple scenes to be shot to produce a corresponding type of video. For example, the multiple scenes may be continuous scenes so that a user generates a video with a continuous plot by using the video generation template. The first trigger operation may be any trigger operation which can trigger an entry to a target template homepage of the target template, such as clicking on a certain recommended template in a creation homepage or clicking on the use control of a certain video production template displayed in a template list page.

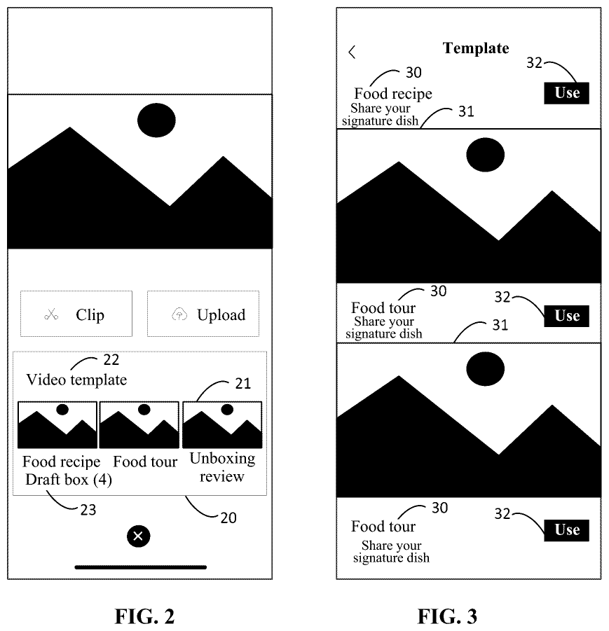

For example, as shown in FIG. 2, the electronic device displays the preset number (such as 4) of recommended templates 21 in a video template display area 20 of the creation homepage. When it is detected that the user clicks on a certain recommended template 21, the recommended template 21 clicked on by the user is determined as the target template, and it is determined that the first trigger operation for using the target template is received. Alternatively, the electronic device displays the preset number of recommended templates 21 in the video template display area 20 of the creation homepage, and when it is detected that the user clicks on a title bar area 22 at the top of the video template display area or when it is detected that the user swipes leftwards to the last recommended template 21 and continues to swipe leftwards, a currently displayed page is switched from the creation homepage to the template list page as shown in FIG. 3, and relevant information about multiple preset video production templates (such as the titles 30 of the video production templates and the video covers 31 of the video examples produced using the video production templates) and the use controls 32 of the multiple preset video production templates are displayed in a video list. Alternatively, when it is detected that the user clicks on a certain recommended template, the currently displayed page is switched from the creation homepage to the template list page, and the recommended template clicked on by the user is automatically moved to the top of the template list page for display. Accordingly, when it is detected that the user clicks on the video cover 31 of a certain video production template displayed in the template list page, the video example of the video production template may be played; and when it is detected that the user clicks on the use control 32 of a certain video production template in the template list page, the video production template may be determined as the target template, and it is determined that the first trigger operation for using the target template is received.

In S102, in response to the first trigger operation, the target template homepage of the target template is displayed and scene description information about multiple target scenes of the target template is displayed in the target template homepage.

A target scene may be understood as a scene of a video which needs to be shot or uploaded and conforms with the target template when a video of the type to which the target template belongs is produced, the target scene is determined based on the target template type/target video type, and different target template types/target video types correspond to different target scenes. For example, when the target template type is the food recipe template, or the target video type is the food recipe video, target scenes of the target template may include an opening introduction, an ingredient introduction, an ingredient production, and the like. Scene description information about the target scene may include scene information about the target scene (such as a scene name and the sequence number of the order of the target scene in the target template homepage) and guidance information (such as shot content information about a scene video) when the scene video of the target scene is shot. The target scene corresponds to the story logic of the target video. The target template homepage may be understood as the template homepage of the target template.

When the electronic device receives the first trigger operation for using the target template, in response to the first trigger operation, the currently displayed page is switched to the target template homepage of the target template, and the scene description information about the target scene in the target template is displayed in the target template homepage. Thus, the user specifies, through the scene description information, the video content of the scene video which needs to be uploaded or shot in a corresponding target scene, that is, the user can add the video which meets the requirements of the corresponding target scene to improve the coherence between multiple plots in a finally generated target video. Multiple preset target scenes may exist in the target template. The multiple target scenes may be arranged in a preset scene sequence in the target template homepage so that the user uploads or shoots videos according to the order of the multiple target scenes in the target template homepage.

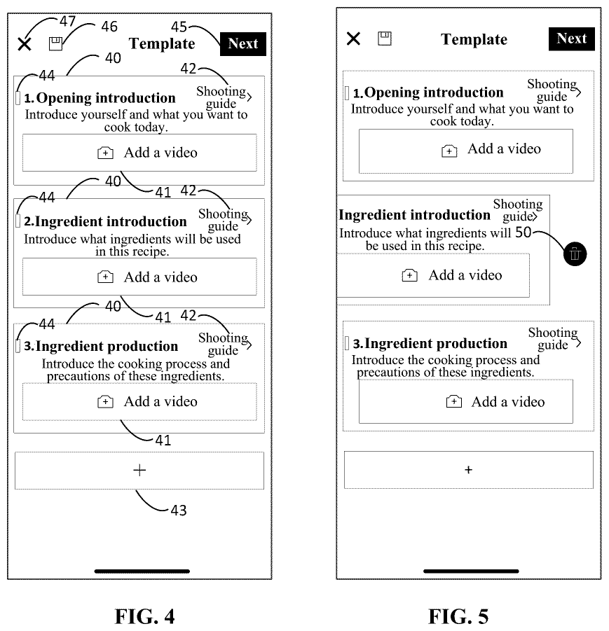

As shown in FIG. 4 (FIG. 4 provides an example in which the target template is the food recipe template), the target template homepage may include multiple scene display areas 40 which are in one-to-one correspondence with the target scenes of the target template, scene description information about one target scene may be displayed in each scene display area, and a video adding control 41 for the user to add a scene video of the corresponding target scene and a shooting guide control 42 for the user to view a shooting guide of the corresponding target scene may also be displayed in each scene display area.

In this embodiment, the target scenes in the target template homepage may or may not support modification by the user (for example, adding and/or deleting the target scene). For example, the target scenes may be configured to support the modification by the user so that a larger creative space is provided for the user and the user experience is improved.

In an implementation, after the scene description information about the multiple target scenes of the target template is displayed in the target template homepage, the method further includes: receiving a fourth trigger operation for deleting a second target scene in the target template homepage; and in response to the fourth trigger operation, deleting the second target scene displayed in the target template homepage.

The second target scene may be understood as a target scene which the user wants to delete. The fourth trigger operation may be any operation for deleting the target scenes in the target template homepage, such as a long press operation acting on the scene display area of a certain target scene or the operation of clicking on the deletion control of a certain target scene. The fourth trigger operation may be configured in advance by the developer as required.

For example, when the user wants to delete a certain target scene in the target template homepage, the user may perform a long press on the scene display area in which the target scene is located (for example, when the electronic device has an Android system). Alternatively, the user may swipe leftwards in the scene display area in which the target scene is located so that the electronic device displays the scene deletion control 50 of the target scene when detecting the operation of swiping leftwards, as shown in FIG. 5, (FIG. 5 provides an example in which the second target scene is the second target scene in the target template homepage), and after the electronic device displays the scene deletion control 50 of the target scene, the user may click on the scene deletion control (for example, when the electronic device has an iOS system). Accordingly, when detecting a long press operation in a certain scene display area or the click operation acting on the scene deletion control 50 of a certain target scene, the electronic device determines the target scene as the second target scene, deletes the target scene from the target template homepage, and may adaptively update the sequence numbers of multiple target scenes remaining in the target template homepage.

In the preceding implementation, after receiving the fourth trigger operation, the electronic device may further display a deletion confirmation pop-up window and the user is reminded by the pop-up window to determine whether the second target scene is deleted or not. In addition, when detecting that the user clicks on a deletion confirmation control in the deletion confirmation pop-up window, the electronic device deletes the second target scene from the target template homepage, and when detecting that the user clicks on a deletion cancellation control in the deletion confirmation pop-up window, the electronic device does not perform the subsequent deletion operation to avoid an accidental deletion.

In another implementation, after the scene description information about the multiple target scenes of the target template is displayed in the target template homepage, the method further includes: receiving a third click operation acting on a scene adding control in the target template homepage; and in response to the third click operation, switching the currently displayed page from the target template homepage to a newly added scene page for the user to input scene description information about a newly added target scene into the newly added scene page.

The newly added target scene may be understood as a target scene which the user needs to add this time.

For example, as shown in FIG. 4, a scene adding control 43 configured to instruct the electronic device to add a new target scene may be provided in the target template homepage; and when the user wants to add the new target scene in the target template homepage, the user may click on the scene adding control 43 in the target template homepage. Accordingly, when detecting that the user clicks on the scene adding control 43 in the target template homepage, the electronic device determines that the third click operation is received, and in response to the third click operation, the electronic device switches the currently displayed page from the target template homepage to the newly added scene page, as shown in FIG. 6. Thus, the user may view the current order number of the newly added target scene in the target template homepage in the newly added scene page, may input a scene name and/or a shot picture overview of the newly added target scene into the newly added scene page, and may add a scene video of the newly added target scene by clicking on a scene video adding control 60 in the newly added scene page.

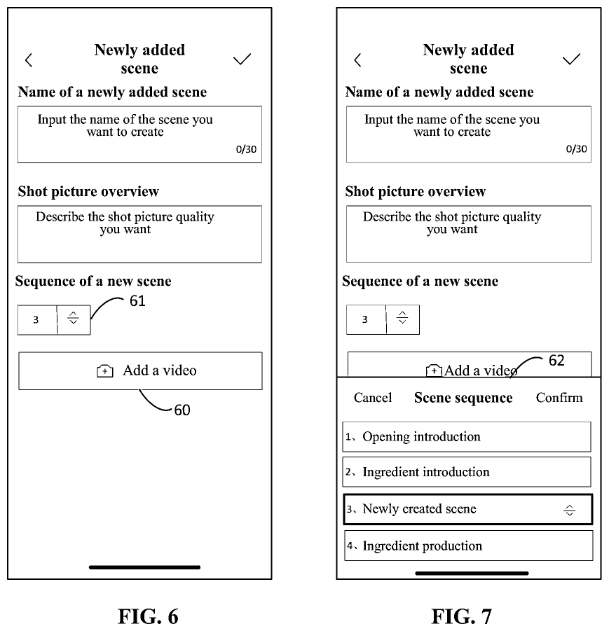

In addition, as shown in FIG. 6, a sequence adjustment control 61 may also be provided in the newly added scene page, and the user may adjust the order of the newly added scene in the target template homepage by clicking on the sequence adjustment control 61. In this case, the video generation method provided in this embodiment may further include: receiving a fourth click operation acting on the sequence adjustment control 61 in the newly added scene page; in response to the fourth click operation, displaying a sequence adjustment window 62, as shown in FIG. 7. Scene identification information about the multiple target scenes is displayed in the sequence adjustment window 62, and the multiple target scenes include the newly added target scene. The video generation method provided in this embodiment may further include: receiving a drag operation acting on newly added scene identification information about the newly added target scene; and in response to the drag operation, adjusting the order of the newly added scene identification information in the sequence adjustment window 62 to adjust the order of the newly added target scene in all the target scenes.

The scene identification information about the target scenes may be understood as information for identifying the multiple target scenes, such as scene names and/or the scene sequence numbers of the target scenes. Accordingly, the newly added scene identification information may be understood as scene identification information about the newly added target scene.

For example, the electronic device displays the sequence adjustment control in the newly added scene page; and when the user wants to adjust the order of the newly added target scene in the target template homepage, the user clicks on the sequence adjustment control. Accordingly, when detecting that the user clicks on the sequence adjustment control in the newly added scene page, the electronic device determines that the fourth click operation is received, and in response to the fourth click operation, the electronic device pops up the sequence adjustment window and displays the scene identification information about the newly added target scene and the scene identification information about the multiple original target scenes in the target template homepage in the sequence adjustment window according to the sequence of all the target scenes. Thus, the user may adjust the sequence of the newly added target scene in all the target scenes by dragging the newly added scene identification information about the newly added target scene. That is, when detecting the drag operation acting on the newly added scene identification information, the electronic device may control the newly added scene identification information to move with the control point of the drag operation and may adjust the sequence of each target scene according to the order of each scene identification information in the sequence adjustment window after the movement. For example, the scene sequence number of each target scene is changed (for the case where the sequence of each target scene is identified by the scene sequence number), and/or, the order of each target scene is adjusted in the target template homepage (for the case where the sequence of each target scene is identified by the order of each target scene in the target template homepage).

It is to be understood that when the user performs a deletion/addition operation on the target scene, the electronic device may respond to the deletion/addition operation of the user regardless of the number of target scenes remaining in the target template homepage at a current time or the number of target scenes which have been added by the user until the current time. When the deletion operation on the target scene by the user is detected, it may be determined whether the number of target scenes in the target template homepage at the current time is less than or equal to a first preset number (such as 1), the deletion operation is responded to based on the determination result that the number of target scenes in the target template homepage at the current time is less than or equal to the first preset number, and the deletion operation is no longer responded to based on the determination result that the number of target scenes in the target template homepage at the current time is greater than the first preset number, so that it is ensured that the number of target scenes provided in the target template homepage is not less than the first preset number; and/or when the addition operation on the target scene by the user is detected, it may be determined whether the number of target scenes added by the user in the target template homepage at the current time is greater than or equal to a second preset number (such as 10), the addition operation is no longer responded to based on the determination result that the number of target scenes added by the user in the target template homepage at the current time is less than or equal to the second preset number, and the addition operation is responded to based on the number of target scenes added by the user in the target template homepage at the current time which is greater than the second preset number, so that the user is prevented from adding too many new target scenes in the target template homepage.

In S103, a second trigger operation for adding a scene video of any target scene is received.

The second trigger operation may be a trigger operation for adding a scene video of a certain target scene, for example, the operation of clicking on a control for uploading a video from a photo album or a shooting control in an addition mode selection window of the target scene in the target template homepage, or the operation of clicking on a video uploading control or a go-to-shoot control in the shooting guide page of the target scene.

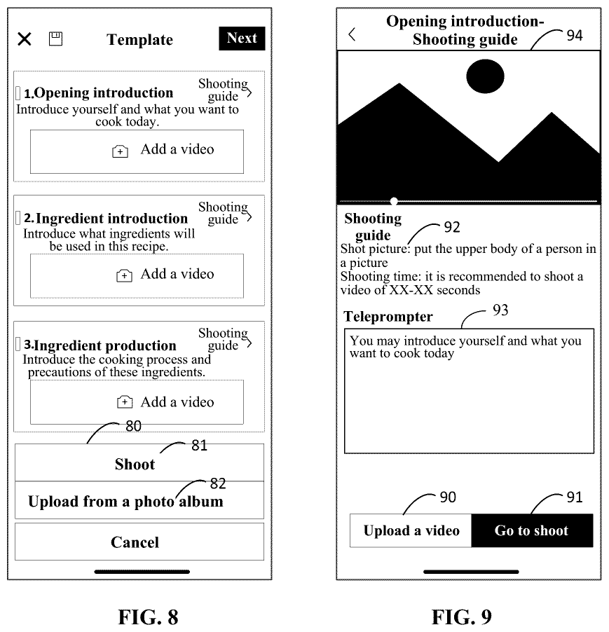

As shown in FIG. 4, when the user wants to add the scene video of the target scene, the user may click on the video adding control 41 of the target scene. Accordingly, when detecting that the user clicks on the video adding control 41, the electronic device may pop up the addition mode selection window 80, as shown in FIG. 8, for the user to select a manner of adding the video, such as shooting the video or uploading the video from the photo album, and when detecting that the user clicks on the shooting control 81 or the control 82 for uploading the video from the photo album in the addition mode selection window 80, the electronic device may determine that the second trigger operation is received. In addition, as shown in FIG. 4, the user may first click on the shooting guide control 42 of the target scene to switch the currently displayed page from the target template homepage of the target template to the shooting guide page of the target scene, as shown in FIG. 9 (FIG. 9 provides an example in which the target scene is the opening introduction scene), so as to view the shooting guide of the target scene, and after viewing the shooting guide, the user may directly click on the video uploading control 90 or the go-to-shoot control 91 in the shooting guide. Thus, when detecting that the user clicks on the video uploading control 90 or the go-to-shoot control 91 in the shooting guide page, the electronic device may determine that the second trigger operation is received.

In S104, in response to the second trigger operation, the scene video of the target scene corresponding to the second trigger operation is added.

For example, when detecting that the user clicks on the shooting control in the addition mode selection window of a certain target scene or the go-to-shoot control in the shooting guide page, the electronic device may switch the currently displayed page from the target template homepage to the video shooting page and turn on a camera to shoot the scene video of the corresponding target scene; and/or when detecting that the user clicks on the control for uploading the video from the photo album in the addition mode selection window of a certain target scene or the video uploading control in the shooting guide page, the electronic device may switch the currently displayed page from the target template homepage to a photo album page and add the video selected by the user from the photo album page as the scene video of the corresponding target scene to the target template homepage.

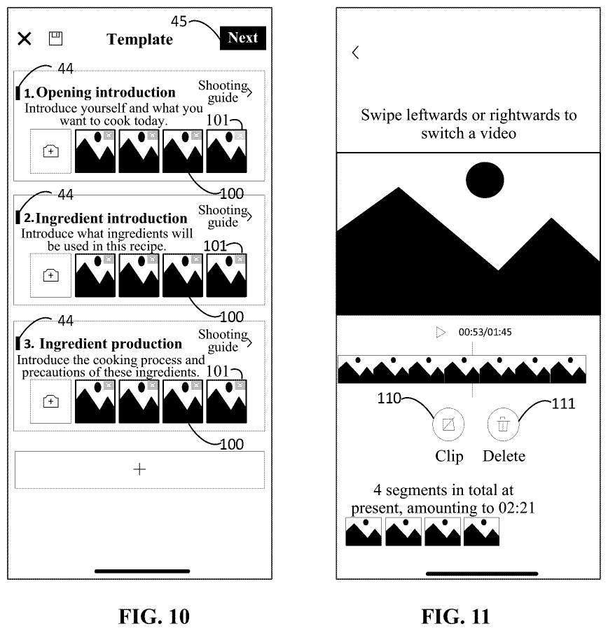

It is to be understood that one or more scene videos may be added in a certain target scene, which is not limited in this embodiment. As shown in FIG. 10, after the scene video is added to a certain target scene, a scene video thumbnail 100 of the scene video may be displayed in the scene video, and video identification 44 in front of the scene sequence number of the target scene is adjusted from a first display state (as shown in FIG. 4) to a second display state so that it is indicated that the scene video has been added to the target scene. When a certain target scene has multiple scene videos, the user may adjust the position of each scene video thumbnail of a target scene video in the target template homepage by dragging the scene video thumbnail leftwards or rightwards to adjust the order of the multiple scene videos of the target scene video.

In addition, scene video deletion controls 101 may be further displayed on the upper layers of multiple scene video thumbnails. Thus, when the user wants to delete a certain scene video which has been added, the user may click on a scene video deletion control 101 on the upper layer of a scene video thumbnail 100 of the scene video. Accordingly, when detecting that the user clicks on the scene video deletion control 101 on the upper layer of the scene video thumbnail 100, the electronic device deletes the scene video to which the scene video thumbnail 100 belongs. Alternatively, the user may view and edit a certain scene video by clicking on the scene video thumbnail 100 of the scene video, for example, the user may click on the scene video thumbnail 100 of the scene video when the user wants to view or edit the scene video. Accordingly, when detecting the click operation acting on the scene video thumbnail 100 of the scene video, the electronic device may switch the currently displayed page from the target template homepage to a video preview page, play the scene video in the video preview page, and display a clipping control 110 and a deletion control 111, as shown in FIG. 11. Thus, the user may instruct, by swiping leftwards or rightwards, the electronic device to switch the scene video played in the video preview page to other scene videos in the same target scene, may clip, by clicking on the clipping control 110 in the video preview page, the scene video currently played in the video preview page, and may instruct, by clicking on the deletion control 111 in the video preview page, the electronic device to delete the scene video currently played in the video preview page.

In S105, scene videos of the multiple target scenes are synthesized into a target video according to the sequence of the multiple target scenes in the target template homepage.

A rule for determining the sequence of the multiple target scenes may be flexibly configured. For example, the sequence of each target scene may be determined according to the scene sequence number of each target scene, or the sequence of the multiple target scenes may be determined according to the sequence numbers of the target scenes from small to large; and/or the sequence of each target scene is determined according to the order of each target scene in the target template homepage, for example, the sequence of the multiple target scenes is determined according to the arrangement position sequence of the multiple target scenes in the target template from front to back, which is not limited in this embodiment.

In this embodiment, the multiple target scenes are coherent scenes which are matched with multiple plots included in the corresponding type of video produced with the target template, that is, the sequence of the multiple target scenes is matched with the sequence of the multiple plots included in the corresponding type of video produced with the target template, and the scene names of the multiple target scenes may also be matched with the content of the multiple plots separately. Therefore, after the scene videos of the multiple target scenes in the target template homepage are each added, the scene videos of the multiple target scenes may be synthesized into the target video according to the sequence of the multiple target scenes. Therefore, it can be ensured that the synthesized target video includes the plots included in the corresponding type of video and the multiple plots included in the target video are coherent plots so that the synthesized target video is narrative, logical, and coherent, thereby better meeting the needs of the user and improving the user experience.

In this embodiment, the method for synthesizing the multiple scene videos into the target video may be configured as required, for example, the multiple scene videos may be directly connected so that the target video is obtained. Alternatively, a transition video may be first added between adjacent videos so that corresponding video effects are added to the multiple scene videos, and/or, volume balance processing or the like is performed on different scene videos and then the multiple processed videos (such as the scene videos and transition videos) are connected so that the target video is obtained.

According to the video generation method provided in this embodiment, the first trigger operation for using the target template is received, in response to the first trigger operation, the target template homepage of the target template is displayed and the scene description information about the multiple target scenes of the target template is displayed in the target template homepage, the second trigger operation for adding the scene video of any target scene is received, in response to the second trigger operation, the scene video of the corresponding target scene is added, and after the addition of the scene videos is completed, the scene videos of the multiple target scenes are synthesized into the target video according to the sequence of the multiple target scenes in the target template homepage. In this embodiment, with the preceding technical solution, the multiple target scenes are provided for the target template in advance according to the story logic of the video and the user is guided by the scene description information about the multiple target scenes to add the scene videos which meet the requirements of the corresponding target scenes. Thus, it is unnecessary for the user to storyboard the shot video manually and the difficulty in producing the video is reduced, and the coherence between the plots of the multiple scene videos can be improved, thereby making the generated video more narrative and logical.

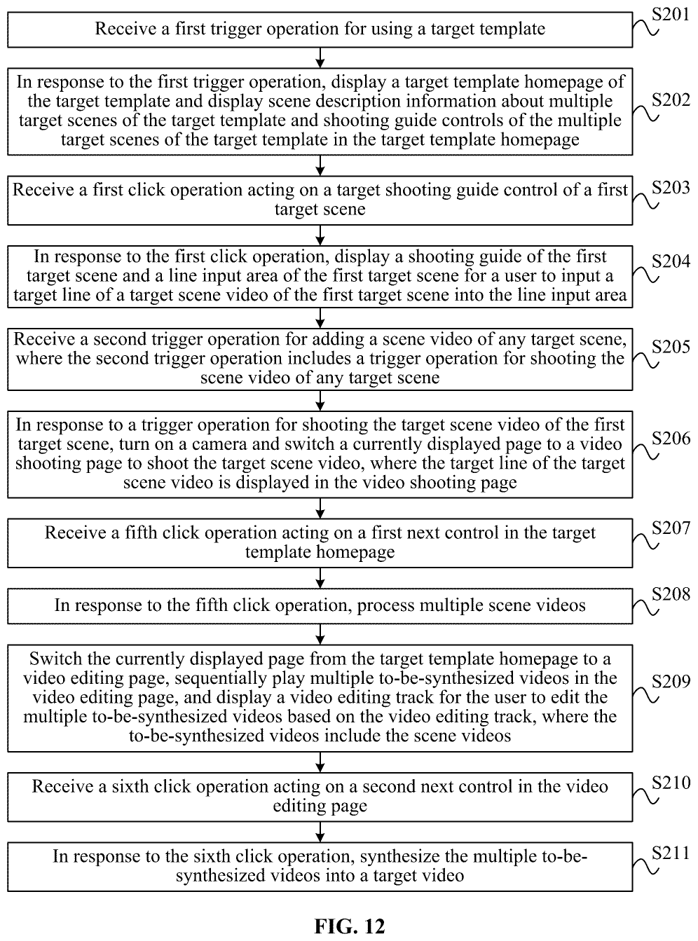

FIG. 12 is a flowchart of another video generation method according to an embodiment of the present disclosure. The solution in this embodiment may be combined with one or more example solutions in the preceding embodiment. The second trigger operation includes a trigger operation for shooting the scene video of any target scene, and in response to the second trigger operation, adding the scene video of the target scene corresponding to the second trigger operation includes: in response to a trigger operation for shooting a target scene video of a first target scene, turning on the camera and switching the currently displayed page to the video shooting page to shoot the target scene video, where a target line of the target scene video is displayed in the video shooting page.

A shooting guide control of each target scene is further displayed in the target template homepage, and the method further includes: receiving a first click operation acting on a target shooting guide control of the first target scene; and in response to the first click operation, displaying a shooting guide of the first target scene and a line input area of the first target scene for the user to input the target line of the target scene video of the first target scene into the line input area.

Synthesizing the scene videos of the multiple target scenes into the target video according to the sequence of the multiple target scenes in the target template homepage includes: receiving a fifth click operation acting on a first next control in the target template homepage; in response to the fifth click operation, processing the multiple scene videos; switching the currently displayed page from the target template homepage to a video editing page, sequentially playing multiple to-be-synthesized videos in the video editing page, and displaying a video editing track for the user to edit the multiple to-be-synthesized videos based on the video editing track, where the to-be-synthesized videos include the scene videos; receiving a sixth click operation acting on a second next control in the video editing page; and in response to the sixth click operation, synthesizing the multiple to-be-synthesized videos into the target video.

As shown in FIG. 12, the video generation method provided in this embodiment may include the steps described below.

In S201, the first trigger operation for using the target template is received.

In S202, in response to the first trigger operation, the target template homepage of the target template is displayed and the scene description information about the multiple target scenes of the target template and shooting guide controls of the multiple target scenes of the target template are displayed in the target template homepage.

In S203, the first click operation acting on the target shooting guide control of the first target scene is received.

In S204, in response to the first click operation, the shooting guide of the first target scene and the line input area of the first target scene are displayed so that the user inputs the target line of the target scene video of the first target scene into the line input area.

The first click operation may be understood as a click operation acting on the shooting guide control. Accordingly, the target shooting guide control may be the shooting guide control on which the first click operation acts, the first target scene may be a target scene corresponding to the target shooting guide control, the target scene video may be a scene video of the first target scene, and the target line is a line used when the target scene video is shot. In this embodiment, the shooting guide of the first target scene and the line input area of the first target scene may be displayed in the target template homepage or may be displayed in another page (for example, the shooting guide page) instead of the target template homepage, which is not limited in this embodiment. Illustration is provided below by using an example in which the shooting guide of the first target scene and the line input area of the first target scene are displayed in the shooting guide page.

As shown in FIG. 9, the shooting guide 92 of the first target scene and the line input area 93 of the first target scene may be displayed in the shooting guide page of the first target scene. That is, in a shooting guide page of a certain target scene, a shooting guide 92 (such as information about a shot picture and shooting time information) of a scene video of the target scene may be displayed, and a line input area 93 may be provided so that the user inputs the line of the scene video of the target scene. An example video playing area 94 of the target scene may also be provided in the shooting guide page of the target scene. Thus, the user can know the shooting mode of the scene video of the target scene by viewing the example video of the target scene.

As shown in FIG. 4, the electronic device displays the scene description information about the multiple target scenes and the shooting guide controls 42 of the multiple target scenes in the target template homepage; and when the user wants to view a shooting guide of a certain target scene in the target template homepage, the user clicks on the shooting guide control 42 of the target scene. Accordingly, when detecting that the user clicks on the shooting guide control 42, the electronic device determines that the first click operation is received, switches the currently displayed page from the target template homepage to the shooting guide page of the target scene, and displays the shooting guide 92 of the target scene and the line input area 93 of the target scene in the shooting guide page, as shown in FIG. 9. Thus, the user may input the target line used when the scene video of the target scene is subsequently shot in advance into the line input area 93 so that the user can directly read the line when the target scene video is subsequently shot, thereby improving the user experience.

In S205, the second trigger operation for adding the scene video of any target scene is received, where the second trigger operation includes the trigger operation for shooting the scene video of any target scene.

In S206, in response to the trigger operation for shooting the target scene video of the first target scene, the camera is turned on and the currently displayed page is switched to the video shooting page so that the target scene video is shot, where the target line of the target scene video is displayed in the video shooting page.

For example, as shown in FIG. 9, the video uploading control 90 or the go-to-shoot control 91 may also be provided in the shooting guide page. Thus, after the target line is inputted into the shooting guide page and when the user wants to shoot the target scene video, the user may click on the go-to-shoot control 91 in the shooting guide page, or the user may control, by clicking on the video adding control of the first target scene in the target template homepage, the electronic device to pop up the addition mode selection window 80 of the first target scene and may click on the shooting control 81 in the addition mode selection window, as shown in FIG. 8. Accordingly, when detecting that the user clicks on the go-to-shoot control 91 in the shooting guide page of a target shooting scene or when detecting that the user clicks on the shooting control 81 in the addition mode selection window 80 of the target shooting scene, the electronic device switches the currently displayed page to the video shooting page and displays the target line in the video shooting page so that the user shoots the target scene video based on the target line.

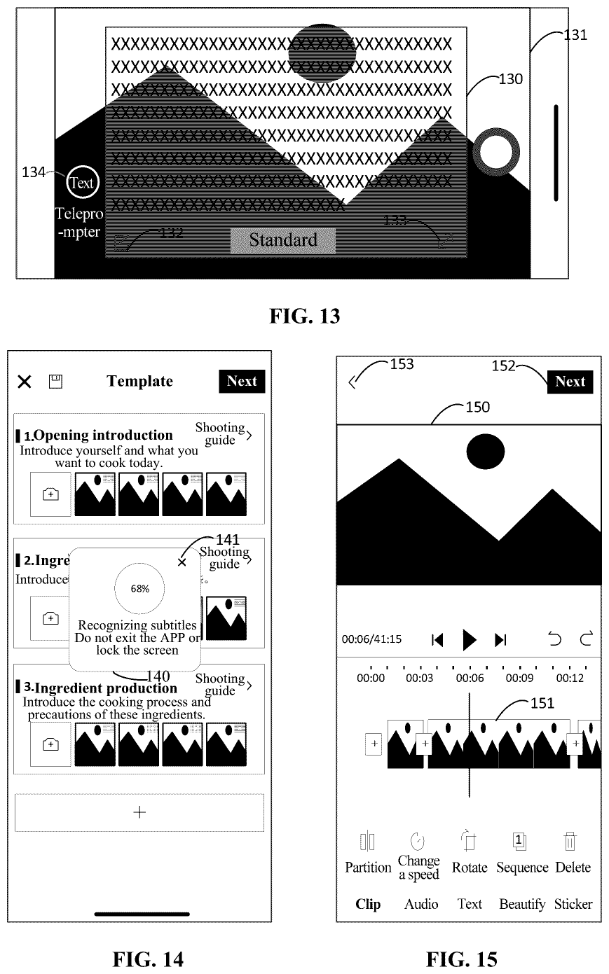

In this embodiment, as shown in FIG. 13 (FIG. 13 provides an example in which the line display area 130 is located on the upper layer of a picture display area 131), the video shooting page may include the picture display area 131 for displaying a picture captured by the camera and the line display area 130 for displaying the target line, where the line display area 130 may be a separate area which does not overlap the picture display area 131 or may be an area located on the upper layer of the picture display area 131, that is, the target line may be displayed on the upper layer of the picture captured by the camera. In addition, a line editing control 132 may be provided in the line display area. Thus, the user may adjust the target line to an editable state by clicking on the line editing control 132 and edit the target line, and after the editing is completed, the user may adjust the target line to a non-editable state by clicking on the line editing control 132 again.

It is to be understood that in this embodiment, the developer may configure, in advance, preset lines when the multiple scene videos (including the target scene video of the first target scene) are shot, and when a shooting guide page of a certain target scene is displayed, a preset line is displayed in the line input area of the shooting guide page of the target scene for the user to modify. If the user does not modify a preset line of a scene video of a certain target scene, the preset line of the target scene may be determined as the target line of the target scene, and when the scene video of the target scene is shot, the target line is displayed in the video shooting page of the scene video of the target scene.

In an implementation, the video generation method provided in this embodiment may further include: receiving a third trigger operation for adjusting the line display area of the target line in the video shooting page; and in response to the third trigger operation, adjusting the position and/or size of the line display area.

In the preceding implementation, the user may adjust the position and/or size of the line display area. As shown in FIG. 13, a size adjustment control 133 for the user to adjust the size of the line display area may be provided in the line display area. Thus, when the user wants to adjust the size of the line display area, the user may click on the size adjustment control 133, and when the user wants to adjust the position of the line display area, the user may swipe in the line display area. Accordingly, when detecting that the user clicks on the size adjustment control 133 in the line display area, the electronic device may adjust (for example, reducing or increasing) the size of the line display area. When detecting the swiping operation acting on the line display area, the electronic device may control the line display area to move with the control point of the swiping operation to adjust the position of the line display area.

In another implementation, the video generation method provided in this embodiment may further include: receiving a second click operation acting on a teleprompter control in the video shooting page; and in response to the second click operation, switching the target line from a displayed state to a hidden state.

In the preceding implementation, as shown in FIG. 13, the teleprompter control 134 configured to instruct the electronic device to display/hide the target line may be provided in the video shooting page. Thus, when the target line is displayed in the video shooting page, if the user wants to control the electronic device to hide (that is, stop displaying) the target line, the user may click on the teleprompter control 134. Accordingly, when detecting that the user clicks on the teleprompter control 134 and determining that the target line is in the displayed state, the electronic device may adjust the target line from the displayed state to the hidden state. When the target line is not displayed in the video shooting page, if the user wants to control the electronic device to display the target line, the user may click on the teleprompter control 134 again. Accordingly, when detecting that the user clicks on the teleprompter control 134 and determining that the target line is in the hidden state, the electronic device may adjust the target line from the hidden state to the displayed state.

In S207, the fifth click operation acting on the first next control in the target template homepage is received.

In S208, in response to the fifth click operation, the multiple scene videos are processed.

The first next control 45 may be understood as a next control provided in the target template homepage. In this embodiment, as shown in FIGS. 4 and 10, the first next control 45 configured to instruct the electronic device to perform a subsequent operation may be provided in the target template homepage. When it is detected that at least one scene video is added to the target template homepage, the first next control 45 may be switched from a non-triggerable state to a triggerable state. Alternatively, when it is detected that at least one scene video is added to each of the multiple target scenes in the target template homepage, the first next control 45 may be switched from a non-triggerable state to a triggerable state. Illustration is provided below by using this case as an example.

When the user completes the addition of all the scene videos of the multiple video scenes to be shot in the template homepage and wants to instruct the electronic device to perform subsequent processing on the multiple scene videos, the user may click on the next control in the target template homepage. Accordingly, when detecting that the user clicks on the next control in the target template homepage, the electronic device may pop up a progress pop-up window 140. As shown in FIG. 14, the progress of effect processing (for example, the addition of the transition video, subtitle recognition, the volume balance processing, video effect addition, and/or the addition of the transition video) is displayed by the progress pop-up window 140, and the multiple scene videos added to the target template homepage are processed. A pop-up window closure control 141 may be provided in the progress pop-up window, and the user may instruct, by clicking on the pop-up window closure control 141, the electronic device to stop displaying the effect processing and close the progress pop-up window 140.

In this embodiment, processing the multiple scene videos includes at least one of: adding a video effect corresponding to each target scene in the target template to the scene video of the target scene, for example, adding a filter, background music, and/or a subtitle style corresponding to the target scene to which each scene video belongs to the scene video; performing the volume balance processing on a scene video of each target scene, for example, automatically aligning the volume of each scene video so as to prevent the volume from fluctuating; or sequencing the multiple scene videos in the target template homepage according to the sequence of each target scene and the order of each scene video in the target scene to which the scene video belongs, and adding the transition video between adjacent scene videos which meet a preset condition, so as to avoid excessively abrupt switches between different scene videos. Here, the preset condition for adding the transition video may be that the difference degree between the first preset number (for example, 1 frame) of video frames at the end of a previous video in two adjacent scene videos and the first preset number of video frames at the start of a subsequent video in the two adjacent scene videos is greater than a preset difference degree threshold, where the difference degree may be determined by a pre-trained model. The transition video added between the two adjacent scene videos may be determined according to the second preset number (for example, 5 frames) of video frames at the end of the previous video and the second preset number of video frames at the start of the subsequent video.

In S209, the currently displayed page is switched from the target template homepage to the video editing page, multiple to-be-synthesized videos are sequentially played in the video editing page, and a video editing track is displayed so that the user edits the multiple to-be-synthesized videos based on the video editing track, where the to-be-synthesized videos include the scene videos.

If the transition videos are added when the multiple scene videos are processed, the to-be-synthesized videos further include the added transition videos so that the user edits the added transition videos, thereby improving the user experience.

In this embodiment, after completing the processing of the multiple scene videos added to the target template homepage and the addition of the transition videos, the electronic device may switch the currently displayed page from the target template homepage to the video editing page of the target template so that the user edits one or more to-be-synthesized videos (including the scene videos and the transition videos) in the video editing page. For example, as shown in FIG. 15, a video playing area 150 for the user to view the multiple to-be-synthesized videos may be provided in the video editing page, and the video editing track for editing the multiple to-be-synthesized videos is displayed in the video editing page. Thus, the user may edit the multiple to-be-synthesized videos through the video editing track, for example, the user clips the to-be-synthesized videos, changes filters, background music, and/or subtitles added to the to-be-synthesized videos, deletes a certain to-be-synthesized video or more to-be-synthesized videos, and/or changes transition effects added to the transition videos. The scene videos and the transition videos in the video editing track may be provided with different video marks so that it is convenient for the user to distinguish the scene videos added by the user from the transition videos automatically added by the electronic device.

In S210, the sixth click operation acting on the second next control in the video editing page is received.

In S211, in response to the sixth click operation, the multiple to-be-synthesized videos are synthesized into the target video.

The second next control may be understood as a next control in the video editing page.

For example, as shown in FIG. 15, the user edits the multiple to-be-synthesized videos in the video editing page. After the editing is completed and when the user wants to synthesize the multiple to-be-synthesized videos into the target video, the user may click the second next control 152 in the video editing page. Accordingly, when detecting that the user clicks on the second next control 152 in the video editing page, the electronic device may determine that the sixth click operation is received and connect the consecutive to-be-synthesized videos end to end to synthesize the to-be-synthesized videos into the target video, and the electronic device may switch the currently displayed page to a video publishing page for the user to publish the synthesized target video in the video publishing page.

In this embodiment, when the electronic device displays the target template homepage, the user may save, by clicking on a first save control in the target template homepage, content currently edited in the target template homepage, and/or the user may exit the target template homepage by clicking on a homepage closure control in the target template homepage; and when the electronic device displays the video editing page, the user may save, by clicking on a second save control in the video editing page, content currently edited in the video editing page, and/or the user may exit the video editing page by clicking on a page return control in the video editing page. When a project file of the target video (that is, an edited target template) to be generated is saved through save controls in different pages, the saving states of the project file may be the same or different, which is not limited in this embodiment.

In an implementation, the file states of the project file of the target video saved through the save controls in the different pages may be different to facilitate differentiation by the user. In this case, the video generation method provided in this embodiment further includes: receiving a seventh click operation acting on the first save control in the target template homepage; and in response to the seventh click operation, saving the project file of the target video as a template draft file whose file state is a template draft state; and/or receiving an eighth click operation acting on the second save control in the video editing page; and in response to the eighth click operation, saving the project file of the target video as a clip draft file whose file state is a clip draft state.

The first save control may be a save control which is in the target template homepage and can be used for instructing the electronic device to save content edited by the user in the target template homepage. For example, the first save control may be a homepage save control which is always in a displayed state in the target template homepage, or the first save control may be a window save control in a closure confirmation window popped up when it is detected that the user clicks on the homepage closure control in the target template homepage. The second save control may be a save control which is in the video editing page and can be used for instructing the electronic device to save content edited by the user in the video editing page, for example, a save and return control in a return confirmation window popped up when it is detected that the user clicks on the page return control in the video editing page.

For example, as shown in FIG. 4, the electronic device displays the target template homepage. When the user wants to save the content edited in the target template homepage, the user clicks on the homepage save control 46 in the target template homepage. When detecting that the user clicks on the homepage save control 46 in the target template homepage, the electronic device determines whether the user edited the content in the target template homepage after the operation of saving the project file of the target video was performed last time. Based on the determination result that the content in the target template homepage was edited by the user, the electronic device saves the project file of the target video and marks the file state of the project file of the target video as the template draft state. Based on the determination result that the content in the target template homepage was not edited by the user, the electronic device does not perform the operation of saving the project file of the target video. Alternatively, when the user wants to close the target template homepage, the user clicks on the homepage closure control 47 in the target template homepage. When detecting that the user clicks on the homepage closure control 47 in the target template homepage, the electronic device determines whether the user performed an editing operation in the target template homepage after the operation of saving the project file of the target video was performed last time. Based on the determination result that the user performed the editing operation in the target template homepage, the electronic device displays the closure confirmation window, saves the project file of the target video, marks the file state of the project file as the template draft state, closes the target template homepage when detecting that the user clicks on the window save control in the closure confirmation window, and closes the target template homepage directly when detecting the user clicks on a direct closure control in the closure confirmation window. Based on the determination result that the user did not perform the editing operation in the target template homepage, the electronic device closes the target template homepage directly.

For example, as shown in FIG. 15, the electronic device displays the video editing page. When the user wants to return to the target template homepage, the user clicks on the page return control 153 in the video editing page. When detecting that the user clicks on the page return control 153 in the video editing page, the electronic device determines whether the user performed the editing operation in the video editing page after the operation of saving the project file of the target video was performed last time. Based on the determination result that the user performed the editing operation in the video editing page, the electronic device displays the return confirmation window, saves the project file of the target video, marks the file state of the project file as the clip draft state, closes the target template homepage when detecting that the user clicks on the save and return control in the return confirmation window, and returns to the target template homepage directly when detecting the user clicks on a direct return control in the return confirmation window. Based on the determination result that the user did not perform the editing operation in the video editing page, the electronic device returns to the target template homepage directly.

In the preceding implementation, after the project file of the target video is saved as the template draft file and/or the clip draft file, the method may further include: receiving a trigger operation for displaying a draft box, displaying a draft box page, and displaying file information about project files of multiple unpublished videos in the draft box page; receiving a ninth click operation acting on file information about any target project file; and in response to the ninth click operation, displaying a target page corresponding to the file state of the target project file, where the target page is a template homepage or the video editing page.

The template homepage may include the target template homepage of the target template to which the target video belongs. The video editing page may include the video editing page of the target template to which the target video belongs. The file information about the project file may include the file cover, the file name, and the file state of the project file and may also include the time of the last update of the project file and the video duration of the project file. The target project file may be understood as the project file to which the file information clicked on by the user in the draft box page belongs. The target page of the template corresponding to the template draft file may be the template homepage of the video production template corresponding to the template draft file. The target page of the template corresponding to the clip draft file may be the video editing page of the video production template corresponding to the clip draft file.

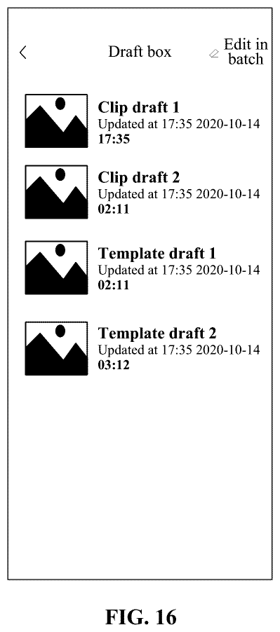

For example, if the user wants to continue editing the content in a template after exiting the template, the user may control the electronic device to display the draft box page through a corresponding trigger operation, for example, the user may control the electronic device to display the draft box page by clicking on a draft box control 23 (as shown in FIG. 2) in the creation homepage. Accordingly, when detecting the trigger operation for displaying the draft box page, the electronic device displays the draft box page as shown in FIG. 16 and displays the file information about the project files of the multiple unpublished videos (including the target video) in the draft box page. Thus, when the user wants to continue editing a certain project file displayed in the draft box page, the user may click on file information about the project file. When the electronic device detects the operation of clicking on the file information about the project file, if the project file is the template draft file, the currently displayed page is switched from the draft box page to the template homepage of the video production template corresponding to the project file, and if the project file is the clip draft file, the currently displayed page is switched from the draft box page to the video editing page of the video production template corresponding to the project file.

According to the video generation method provided in this embodiment, when the user shoots the scene video, the line inputted by the user in advance is displayed in the video shooting page, the transition video corresponding to the adjacent scene videos which meet the preset condition is added to the adjacent scene videos when the switch to the video editing page is performed, and the user is supported to edit the multiple scene videos and the multiple transition videos separately in the video editing page. Thus, the difficulty in shooting and producing the video can be reduced, the synthesized target video better meets the user's wishes, the visual effect of the synthesized target video can be improved, and an excessively abrupt transition is avoided.

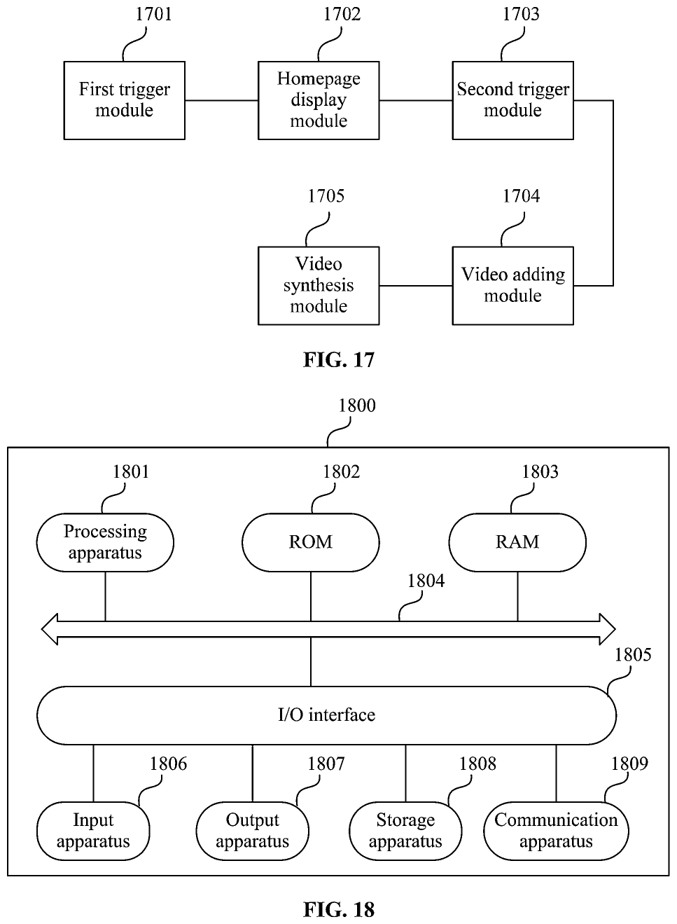

FIG. 17 is a block diagram of a video generation apparatus according to an embodiment of the present disclosure. The apparatus may be implemented in software and/or hardware and may be configured in an electronic device such as a mobile phone or a tablet computer. The apparatus can perform a video generation method to generate a video. As shown in FIG. 17, the video generation apparatus provided in this embodiment may include a first trigger module 1701, a homepage display module 1702, a second trigger module 1703, a video adding module 1704, and a video synthesis module 1705.

The first trigger module 1701 is configured to receive a first trigger operation for using a target template.

The homepage display module 1702 is configured to, in response to the first trigger operation, display a target template homepage of the target template and display scene description information about multiple target scenes of the target template in the target template homepage.

The second trigger module 1703 is configured to receive a second trigger operation for adding a scene video of any target scene.

The video adding module 1704 is configured to, in response to the second trigger operation, add a scene video of a target scene corresponding to the second trigger operation.

The video synthesis module 1705 is configured to synthesize scene videos of the multiple target scenes into a target video according to the sequence of the multiple target scenes in the target template homepage.

In the video generation apparatus provided in this embodiment, the first trigger operation for using the target template is received by the first trigger module, the target template homepage of the target template is displayed by the homepage display module in response to the first trigger operation and the scene description information about the multiple target scenes of the target template is displayed by the homepage display module in the target template homepage, the second trigger operation for adding the scene video of any target scene is received by the second trigger module, the scene video of the corresponding target scene is added by the video adding module in response to the second trigger operation, and after the addition of the scene video is completed, the scene videos of the multiple target scenes are synthesized into the target video by the video synthesis module according to the order of the multiple target scenes in the target template homepage. In this embodiment, with the preceding technical solution, the multiple target scenes are provided for the target template in advance according to the story logic of the video and a user is guided by the scene description information about the multiple target scenes to add the scene videos which meet the requirements of the corresponding target scenes. Thus, it is unnecessary for the user to storyboard the shot video manually and the difficulty in producing the video is reduced, and the coherence between the plots of the multiple scene videos can be improved, thereby making the generated video more narrative and logical.

The second trigger operation includes a trigger operation for shooting the scene video of any target scene, and the video adding module 1704 is configured to, in response to a trigger operation for shooting a target scene video of a first target scene, turn on a camera and switch a currently displayed page to a video shooting page to shoot the target scene video, where a target line of the target scene video is displayed in the video shooting page.

A shooting guide control of each target scene is further displayed in the target template homepage, and the video generation apparatus provided in this embodiment further includes: a first click module configured to receive a first click operation acting on a target shooting guide control of the first target scene; and a guide display module configured to, in response to the first click operation, display a shooting guide of the first target scene and a line input area of the first target scene for the user to input the target line of the target scene video of the first target scene into the line input area.

The video generation apparatus provided in this embodiment further includes: a third trigger module configured to receive a third trigger operation for adjusting a line display area of the target line in the video shooting page; and an area adjustment module configured to, in response to the third trigger operation, adjust the position and/or size of the line display area.

The video generation apparatus provided in this embodiment further includes: a second click module configured to receive a second click operation acting on a teleprompter control in the video shooting page; and a state switch module configured to, in response to the second click operation, switch the target line from a displayed state to a hidden state.

The video generation apparatus provided in this embodiment further includes: a fourth trigger module configured to receive a fourth trigger operation for deleting a second target scene in the target template homepage after the scene description information about the multiple target scenes of the target template is displayed in the target template homepage; and a scene deletion module configured to, in response to the fourth trigger operation, delete the second target scene displayed in the target template homepage.

The video generation apparatus provided in this embodiment further includes: a third click module configured to receive a third click operation acting on a scene adding control in the target template homepage after the scene description information about the multiple target scenes of the target template is displayed in the target template homepage; and a scene adding module configured to, in response to the third click operation, switch the currently displayed page from the target template homepage to a newly added scene page for the user to input scene description information about a newly added target scene into the newly added scene page.

The video generation apparatus provided in this embodiment further includes: a fourth click module configured to receive a fourth click operation acting on a sequence adjustment control in the newly added scene page; a window display module configured to, in response to the fourth click operation, display a sequence adjustment window, where scene identification information about the multiple target scenes is displayed in the sequence adjustment window, and the multiple target scenes include the newly added target scene; an identification drag module configured to receive a drag operation acting on newly added scene identification information about the newly added target scene; and a sequence adjustment module configured to, in response to the drag operation, adjust the order of the newly added scene identification information in the sequence adjustment window to adjust the order of the newly added target scene in all the target scenes.

The video synthesis module 1705 includes: a fifth click unit configured to receive a fifth click operation acting on a first next control in the target template homepage; a video processing unit configured to, in response to the fifth click operation, process multiple scene videos; an editing page display unit configured to switch the currently displayed page from the target template homepage to a video editing page, sequentially play multiple to-be-synthesized videos in the video editing page, and display a video editing track for the user to edit the multiple to-be-synthesized videos based on the video editing track, where the to-be-synthesized videos include the scene videos; a sixth click unit configured to receive a sixth click operation acting on a second next control in the video editing page; and a video synthesis unit configured to, in response to the sixth click operation, synthesize the multiple to-be-synthesized videos into the target video.

In the preceding solution, the video processing unit may be configured to perform at least one of: adding a video effect corresponding to each target scene in the target template to a scene video of the target scene; performing volume balance processing on a scene video of each target scene; or sequencing the multiple scene videos according to the sequence of each target scene and the order of each scene video in a corresponding target scene, and adding a transition video between two adjacent scene videos which meet a preset addition condition, where the transition video corresponds to the two adjacent scene videos. Accordingly, the to-be-synthesized videos further include the transition video.

The video generation apparatus provided in this embodiment further includes: a first save module configured to receive a seventh click operation acting on a first save control in the target template homepage and save, in response to the seventh click operation, a project file of the target video as a template draft file whose file state is a template draft state; and/or a second save module configured to receive an eighth click operation acting on a second save control in the video editing page and save, in response to the eighth click operation, a project file of the target video as a clip draft file whose file state is a clip draft state.

The video generation apparatus provided in the embodiment of the present disclosure may perform the video generation method provided in any embodiment of the present disclosure, and has functional modules and beneficial effects corresponding to the video generation method. For technical details not described in detail in the embodiment, reference may be made to the video generation method provided in any embodiment of the present disclosure.

Reference is made to FIG. 18 below, which illustrates a structural diagram of an electronic device (for example, a terminal device) 1800 for implementing embodiments of the present disclosure. The terminal device in the embodiments of the present disclosure may include, but is not limited to, a mobile terminal such as a mobile phone, a laptop, a digital broadcast receiver, a PDA (Personal Digital Assistant), a PAD (Tablet Computer), a PMP (Portable Multimedia Player), and an in-vehicle terminal (such as an in-vehicle navigation terminal), and a stationary terminal such as a digital TV and a desktop computer. The electronic device shown in FIG. 18 is only an example and should not impose any limitation on the function and scope of use of the embodiments of the present disclosure.

As shown in FIG. 18, the electronic device 1800 may include a processing apparatus (such as a central processing unit or a graphics processing unit) 1801. The processing apparatus 1801 may perform various appropriate actions and processing according to a program stored in a read-only memory (ROM) 1802 or a program loaded from a storage apparatus 1806 into a random-access memory (RAM) 1803. Various programs and data necessary for the operation of the electronic device 1800 are also stored in the RAM 1803. The processing apparatus 1801, the ROM 1802, and the RAM 1803 are connected to each other through a bus 1804. An input/output (I/O) interface 1805 is also connected to the bus 1804.

Generally, the following apparatuses may be connected to the I/O interface 1805: an input apparatus 1806 such as a touch screen, a touchpad, a keyboard, a mouse, a camera, a microphone, an accelerometer, and a gyroscope; an output apparatus 1807 such as a liquid crystal display (LCD), a speaker, and a vibrator; the storage apparatus 1806 such as a magnetic tape and a hard disk; and a communication apparatus 1809. The communication apparatus 1809 may allow the electronic device 1800 to communicate wirelessly or by wire with another device to exchange data. Although FIG. 18 illustrates the electronic device 1800 having various apparatuses, it is to be understood that not all of the illustrated apparatuses are implemented or available. Alternatively, more or fewer apparatuses may be implemented or available.

According to the embodiments of the present disclosure, the processes described above with reference to the flowcharts may be implemented as computer software programs. For example, a computer program product is provided in the embodiments of the present disclosure. The computer program product includes a computer program carried on a non-transitory computer-readable medium. The computer program includes program codes for performing the methods illustrated in the flowcharts. In such an embodiment, the computer program may be downloaded and installed from the network via the communication apparatus 1809, or may be installed from the storage apparatus 1806, or may be installed from the ROM 1802. When the computer program is executed by the processing apparatus 1801, the preceding functions defined in the methods according to the embodiments of the present disclosure are performed.

It is to be noted that the preceding computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or a flash memory), an optical fiber, a portable compact disk read-only memory (CD-ROM), an optical memory device, a magnetic memory device, or any appropriate combination thereof. In the present disclosure, the computer-readable storage medium may be any tangible medium including or storing a program. The program may be used by or in conjunction with an instruction execution system, apparatus, or device. In the present disclosure, however, the computer-readable signal medium may include a data signal propagated in baseband or as part of a carrier wave, where computer-readable program codes are carried in the data signal. The data signal propagated in this manner may be in various forms, including, but not limited to, an electromagnetic signal, an optical signal, or any appropriate combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes embodied on the computer-readable medium may be transmitted via any appropriate medium including, but not limited to, an electrical wire, an optical cable, a radio frequency (RF), or any appropriate combination thereof.

In some implementations, clients and servers may communicate using any currently known or future developed network protocol such as the HTTP (HyperText Transfer Protocol) and may be interconnected with any form or medium of digital data communication (such as a communication network). Examples of the communication network include a local area network (“LAN”), a wide area network (“WAN”), an internet (such as the Internet), a peer-to-peer network (such as an ad hoc peer-to-peer network), as well as any currently known or future developed network.

The preceding computer-readable medium may be included in the preceding electronic device or may exist alone without being assembled into the electronic device.

The preceding computer-readable medium carries one or more programs. When the one or more programs are executed by the electronic device, the electronic device is configured to: receive a first trigger operation for using a target template; in response to the first trigger operation, display a target template homepage of the target template and display scene description information about multiple target scenes of the target template in the target template homepage; receive a second trigger operation for adding a scene video of any target scene; in response to the second trigger operation, add a scene video of a target scene corresponding to the second trigger operation; and synthesize scene videos of the multiple target scenes into a target video according to the sequence of the multiple target scenes in the target template homepage.

Computer program codes for performing the operations in the present disclosure may be written in one or more programming languages or a combination thereof. The preceding programming languages include, but are not limited to, object-oriented programming languages such as Java, Smalltalk, C++, and conventional procedural programming languages such as the “C” language or similar programming languages. The program codes may be executed entirely on a user computer, executed partly on a user computer, executed as a stand-alone software package, executed partly on a user computer and partly on a remote computer, or executed entirely on a remote computer or a server. In case of the remote computer, the remote computer may be connected to the user computer via any kind of network including a local area network (LAN) or a wide area network (WAN). Alternatively, the remote computer may be connected to an external computer (for example, over the Internet provided by an Internet service provider).

The flowcharts and block diagrams in the drawings illustrate possible architectures, functions and operations of the system, method and computer program product according to the embodiments of the present disclosure. In this regard, each block in the flowcharts or block diagrams may represent a module, a program segment, or part of codes. The module, program segment, or part of codes contains one or more executable instructions for implementing specified logical functions. It is also to be noted that in some alternative implementations, the functions marked in the blocks may be implemented in an order different from those marked in the drawings. For example, two successive blocks may, in fact, be performed substantially in parallel or in a reverse order, which depends on the functions involved. It is also to be noted that each block in the block diagrams and/or flowcharts and a combination of blocks in the block diagrams and/or flowcharts may be implemented by a specific-purpose hardware-based system which performs specified functions or operations or a combination of specific-purpose hardware and computer instructions.

The units involved in the embodiments of the present disclosure may be implemented by software or hardware. The name of a module does not limit the module in a certain case.

The functions described herein above may be performed, at least partially, by one or more hardware logic components. For example, without limitation, example types of hardware logic components that may be used include: a field-programmable gate array (FPGA), an application-specific integrated circuit (ASIC), an application-specific standard product (ASSP), a system on chip (SOC), a complex programmable logic device (CPLD), and the like.

In the context of the present disclosure, the machine-readable medium may be a tangible medium that may include or store a program used by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device or any appropriate combination thereof. More specific examples of the machine-readable storage medium may include an electrical connection with one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical memory device, a magnetic memory device, or any appropriate combination thereof.

According to one or more embodiments of the present disclosure, example one provides a video generation method. The method includes the steps described below.

A first trigger operation for using a target template is received.

In response to the first trigger operation, a target template homepage of the target template is displayed and scene description information about multiple target scenes of the target template is displayed in the target template homepage.

A second trigger operation for adding a scene video of any target scene is received.

In response to the second trigger operation, a scene video of a target scene corresponding to the second trigger operation is added.

Scene videos of the multiple target scenes are synthesized into a target video according to the sequence of the multiple target scenes in the target template homepage.

According to one or more embodiments of the present disclosure, according to the method described in example one, in example two, the second trigger operation includes a trigger operation for shooting the scene video of any target scene, and in response to the second trigger operation, adding the scene video of the target scene corresponding to the second trigger operation includes the step described below.

In response to a trigger operation for shooting a target scene video of a first target scene, a camera is turned on and a currently displayed page is switched to a video shooting page so that the target scene video is shot, where a target line of the target scene video is displayed in the video shooting page.

According to one or more embodiments of the present disclosure, according to the method described in example two, in example three, a shooting guide control of each target scene is further displayed in the target template homepage, and the method further includes the steps described below.

A first click operation acting on a target shooting guide control of the first target scene is received.

In response to the first click operation, a shooting guide of the first target scene and a line input area of the first target scene are displayed so that the user inputs the target line of the target scene video of the first target scene into the line input area.

According to one or more embodiments of the present disclosure, according to the method described in example two, in example four, the method further includes the steps described below.

A third trigger operation for adjusting a line display area of the target line in the video shooting page is received.

In response to the third trigger operation, the position and/or size of the line display area is adjusted.

According to one or more embodiments of the present disclosure, according to the method described in example two, in example five, the method further includes the steps described below.

A second click operation acting on a teleprompter control in the video shooting page is received.

In response to the second click operation, the target line is switched from a displayed state to a hidden state.

According to one or more embodiments of the present disclosure, according to the method described in example one, in example six, after the scene description information about the multiple target scenes of the target template is displayed in the target template homepage, the method further includes the steps described below.

A fourth trigger operation for deleting a second target scene in the target template homepage is received.

In response to the fourth trigger operation, the second target scene displayed in the target template homepage is deleted.

According to one or more embodiments of the present disclosure, according to the method described in example one, in example seven, after the scene description information about the multiple target scenes of the target template is displayed in the target template homepage, the method further includes the steps described below.

A third click operation acting on a scene adding control in the target template homepage is received.

In response to the third click operation, the currently displayed page is switched from the target template homepage to a newly added scene page so that the user inputs scene description information about a newly added target scene into the newly added scene page.

According to one or more embodiments of the present disclosure, according to the method described in example seven, in example eight, the method further includes the steps described below.

A fourth click operation acting on a sequence adjustment control in the newly added scene page is received.

In response to the fourth click operation, a sequence adjustment window is displayed, where scene identification information about the multiple target scenes is displayed in the sequence adjustment window, and the multiple target scenes include the newly added target scene.

A drag operation acting on newly added scene identification information about the newly added target scene is received.

In response to the drag operation, the order of the newly added scene identification information is adjusted in the sequence adjustment window so that the order of the newly added target scene is adjusted in all the target scenes.

According to one or more embodiments of the present disclosure, according to the method described in any one of examples one to eight, in example nine, synthesizing the scene videos of the multiple target scenes into the target video according to the sequence of the multiple target scenes in the target template homepage includes the steps described below.

A fifth click operation acting on a first next control in the target template homepage is received.

In response to the fifth click operation, multiple scene videos are processed.

The currently displayed page is switched from the target template homepage to a video editing page, multiple to-be-synthesized videos are sequentially played in the video editing page, and a video editing track is displayed so that the user edits the multiple to-be-synthesized videos based on the video editing track, where the multiple to-be-synthesized videos include the scene videos.

A sixth click operation acting on a second next control in the video editing page is received.

In response to the sixth click operation, the multiple to-be-synthesized videos are synthesized into the target video.

According to one or more embodiments of the present disclosure, according to the method described in example nine, in example ten, processing the multiple scene videos includes at least one of the steps described below.

A video effect corresponding to each target scene in the target template is added to a scene video of the target scene.

Volume balance processing is performed on a scene video of each target scene.

The multiple scene videos are sequenced according to the sequence of each target scene and the order of each scene video in a corresponding target scene, and a transition video is added between two adjacent scene videos which meet a preset addition condition, where the transition video corresponds to the two adjacent scene videos. Accordingly, the to-be-synthesized videos further include the transition video.

According to one or more embodiments of the present disclosure, according to the method described in example nine, in example eleven, the method further includes the steps described below.

A seventh click operation acting on a first save control in the target template homepage is received.

In response to the seventh click operation, a project file of the target video is saved as a template draft file whose file state is a template draft state.

An eighth click operation acting on a second save control in the video editing page is received.

In response to the eighth click operation, a project file of the target video is saved as a clip draft file whose file state is a clip draft state.

According to one or more embodiments of the present disclosure, example twelve provides a video generation apparatus. The apparatus includes a first trigger module, a homepage display module, a second trigger module, a video adding module, and a video synthesis module.

The first trigger module is configured to receive a first trigger operation for using a target template.

The homepage display module is configured to, in response to the first trigger operation, display a target template homepage of the target template and display scene description information about multiple target scenes of the target template in the target template homepage.

The second trigger module is configured to receive a second trigger operation for adding a scene video of any target scene.

The video adding module is configured to, in response to the second trigger operation, add a scene video of a target scene corresponding to the second trigger operation.

The video synthesis module is configured to synthesize scene videos of the multiple target scenes into a target video according to the sequence of the multiple target scenes in the target template homepage.

According to one or more embodiments of the present disclosure, example thirteen provides an electronic device.

The electronic device includes one or more processors and a memory.

The memory is configured to store one or more programs.

When executed by the one or more processors, the one or more programs cause the one or more processors to implement the video generation method according to any one of examples one to eleven.

According to one or more embodiments of the present disclosure, example fourteen provides a non-transitory computer-readable storage medium storing a computer program which, when executed by a processor, implements the video generation method according to any one of examples one to eleven.

In addition, although operations are illustrated in a particular order, it should not be construed as that the operations are required to be performed in the particular order shown or in a sequential order. Under certain circumstances, multitasking and parallel processing may be advantageous. Similarly, although several specific implementation details are included in the preceding discussion, these should not be construed as limitations on the scope of the present disclosure. Certain features described in the context of separate embodiments may also be implemented in combination in a single embodiment. Rather, features described in the context of a single embodiment may be implemented in multiple embodiments separately or in any appropriate sub-combination.

What is claimed is:

1. A video generation method, comprising:
receiving a first trigger operation for using a target template;
in response to the first trigger operation, displaying a target template homepage of the target template and displaying scene description information about a plurality of target scenes of the target template in the target template homepage;
receiving a second trigger operation for adding a scene video of a target scene of the plurality of target scenes;
in response to the second trigger operation, adding the scene video of the target scene corresponding to the second trigger operation; and
synthesizing scene videos of the plurality of target scenes into a target video according to a sequence of the plurality of target scenes in the target template homepage.

2. The method according to claim 1, wherein the second trigger operation comprises a trigger operation for shooting the scene video of the target scene, and in response to the second trigger operation, adding the scene video of the target scene corresponding to the second trigger operation comprises:
in response to a trigger operation for shooting a target scene video of a first target scene, switching a currently displayed page to a video shooting page to shoot the target scene video, wherein a target line of the target scene video is displayed in the video shooting page.

3. The method according to claim 2, wherein a shooting guide control of each target scene is further displayed in the target template homepage, and the method further comprises:
receiving a first click operation acting on a target shooting guide control of the first target scene; and
in response to the first click operation, displaying a shooting guide of the first target scene and a line input area of the first target scene, wherein the line input area is used for a user to input the target line of the target scene video of the first target scene.

4. The method according to claim 2, further comprising:
receiving a third trigger operation for adjusting a line display area of the target line in the video shooting page; and
in response to the third trigger operation, adjusting at least one of a position or a size of the line display area.

5. The method according to claim 2, further comprising:
receiving a second click operation acting on a teleprompter control in the video shooting page; and
in response to the second click operation, switching the target line from being in a displayed state to being in a hidden state.

6. The method according to claim 1, wherein after displaying the scene description information about the plurality of target scenes of the target template in the target template homepage, the method further comprises:
receiving a fourth trigger operation for deleting a second target scene in the target template homepage; and
in response to the fourth trigger operation, deleting the second target scene displayed in the target template homepage.

7. The method according to claim 1, wherein after displaying the scene description information about the plurality of target scenes of the target template in the target template homepage, the method further comprises:
receiving a third click operation acting on a scene adding control in the target template homepage; and
in response to the third click operation, switching a currently displayed page from being the target template homepage to being a newly added scene page, wherein the newly added scene page is used for a user to input scene description information about a newly added target scene.

8. The method according to claim 7, further comprising:
receiving a fourth click operation acting on a sequence adjustment control in the newly added scene page;
in response to the fourth click operation, displaying a sequence adjustment window, wherein scene identification information about the plurality of target scenes is displayed in the sequence adjustment window, and the plurality of target scenes comprise the newly added target scene;
receiving a drag operation acting on newly added scene identification information about the newly added target scene; and
in response to the drag operation, adjusting an order of the newly added scene identification information in the sequence adjustment window to adjust the order of the newly added target scene in the plurality of target scenes.

9. The method according to claim 1, wherein synthesizing the scene videos of the plurality of target scenes into the target video according to the sequence of the plurality of target scenes in the target template homepage comprises:
receiving a fifth click operation acting on a first next control in the target template homepage;
in response to the fifth click operation, processing the scene video of each of the plurality of target scenes;
switching the currently displayed page from being the target template homepage to being a video editing page, sequentially playing a plurality of to-be-synthesized videos in the video editing page, and displaying a video editing track for the user to edit the plurality of to-be-synthesized videos based on the video editing track, wherein the plurality of to-be-synthesized videos comprise the scene videos;
receiving a sixth click operation acting on a second next control in the video editing page; and
in response to the sixth click operation, synthesizing the plurality of to-be-synthesized videos into the target video.

10. The method according to claim 9, wherein processing the scene video of each of the plurality of target scenes comprises at least one of:
adding a video effect corresponding to each target scene in the target template to a scene video of each target scene;
performing volume balance processing on the scene video of each target scene; or
sequencing the scene videos according to a sequence of each target scene and an order of each scene video in a corresponding target scene, and adding a transition video between two adjacent scene videos which meet a preset addition condition, wherein the transition video corresponds to the two adjacent scene videos; wherein the plurality of to-be-synthesized videos further comprise the transition video.

11. The method according to claim 9, further comprising at least one of:
after displaying the target template homepage of the target template, receiving a seventh click operation acting on a first save control in the target template homepage; and in response to the seventh click operation, saving a project file of the target video as a template draft file whose file state is a template draft state; or
after switching the currently displayed page from the target template homepage to the video editing page, receiving an eighth click operation acting on a second save control in the video editing page; and in response to the eighth click operation, saving a project file of the target video as a clip draft file whose file state is a clip draft state.

12. An electronic device, comprising:
at least one processor; and
a memory configured to store at least one program,
wherein when executed by the at least one processor, the at least one program causes the at least one processor to implement:
receiving a first trigger operation for using a target template;
in response to the first trigger operation, displaying a target template homepage of the target template and displaying scene description information about a plurality of target scenes of the target template in the target template homepage;
receiving a second trigger operation for adding a scene video of a target scene of the plurality of target scenes;
in response to the second trigger operation, adding the scene video of the target scene corresponding to the second trigger operation; and
synthesizing scene videos of the plurality of target scenes into a target video according to a sequence of the plurality of target scenes in the target template homepage.

13. A non-transitory computer-readable storage medium storing a computer program which, when executed by a processor, implements the video generation method according to claim 1.
